(19) United States
(12) Patent Application Publication
(10) Pub. No.: US 2023/0260044 A1
(43) Pub. Date: Aug. 17, 2023

(54) GENERATION METHOD AND INFORMATION PROCESSING APPARATUS

(71) Applicant: Fujitsu Limited, Kawasaki-shi (JP)

(72) Inventors: Mayuko Kaneko, Kawasaki (JP); Kentaro Tsuji, Kawasaki (JP); Toshiyuki Yoshitake, Kawasaki (JP); Masayoshi Shimizu, Hadano (JP)

(73) Assignee: Fujitsu Limited, Kawasaki-shi (JP)

(21) Appl. No.: 18/072,020

(22) Filed: Nov. 30, 2022

(30) Foreign Application Priority Data
Feb. 16, 2022 (JP) 2022-021929

(51) Int. Cl. G06Q 40/08; G06F 40/20; G06Q 50/00; G06F 16/9536

(52) U.S. Cl. CPC G06Q 40/08; G06F 40/20; G06Q 50/01; G06F 16/9536

(57) ABSTRACT

A generation method includes extracting, by a computer, a tendency of topics shared by a group to which a user of a social networking service belongs; and generating information that indicates, based on the tendency of topics, a probability of the user spreading posted fake information.

### CROSS-REFERENCE TO RELATED APPLICATION

This application is based upon and claims the benefit of priority of the prior Japanese Patent Application No. 2022-21929, filed on Feb. 16, 2022, the entire contents of which are incorporated herein by reference.

### FIELD

The embodiments discussed herein are related to a generation method and an information processing apparatus.

### BACKGROUND

Information including, news, stories, and the like is quoted from various news sources in curation media and social media. As these media develop further, individuals tend to submit the information more easily. As a result, the immediacy, variety, ease of sharing, and the like of information increase while fake information such as so-called fake news spreads.

From such a background, a related-art technique has been proposed in which, to find users who are likely to spread fake information, users who have spread fake information are extracted based on the degree of spreading of fake information having been spread in the past.

Japanese Laid-open Patent Publication No. 2013-77155 is disclosed as related art. The followings are also disclosed as related art: MATSUNO, et al., “Verifying the impact of user follower composition on the spreadability of SNS post” (The 35th Annual Conference of the Japanese Society for Artificial Intelligence, 2021); TORIUMI, Fujio, SAKAKI, Takeshi, YOSHIDA, Mitsuo, “Social Emotions Under the Spread of COVID-19 Using Social Media”, Short Paper of Journal of The Japanese Society for Artificial Intelligence, Vol. 35, No. 4, p. F-K45, 1-7, Jul., 2020; S. Kullback and R. A. Leibler, “On Information and Sufficiency”, The Annals of Mathematical Statistics, Vol. 22, No. 1, pp. 79-86, March, 1951; and SASAHARA, K., CHEN, W., PENG, H. et al., “Social influence and unfollowing accelerate the emergence of echo chambers.” Journal of computer Social Science, 4, 381-402 (2021).

### SUMMARY

According to an aspect of the embodiments, a generation method includes extracting, by a computer, a tendency of topics shared by a group to which a user of a social networking service belongs; and generating information that indicates, based on the tendency of topics, a probability of the user spreading posted fake information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration example of a cyber insurance examination system;

FIG. 2 is a diagram illustrating an extraction example (1) of fake information spreading user;

FIG. 3 is a diagram illustrating an extraction example (2) of the fake information spreading user;

FIG. 4 is a diagram illustrating a functional configuration example of an examination server;

FIG. 5 is a diagram illustrating an example of extraction of personal characteristics and environmental characteristics;

FIG. 6 is a diagram illustrating a generation example (1) of a fake-information potential spreading user coefficient;

FIG. 7 is a diagram illustrating a generation example (2) of the fake-information potential spreading user coefficient;

FIG. 8 is a flowchart illustrating a procedure of a generating process; and

FIG. 9 is a diagram illustrating a hardware configuration example.

### DESCRIPTION OF EMBODIMENTS

With the above-described related art, only users who have experience of spreading fake information in the past are extracted. Thus, in a facet, it is difficult to extract users who have no experience of spreading fake information in the past. For example, although the users who have no experience of spreading fake information in the past may also include users with high possibility of spreading fake information, so-called potential users, extraction of such potential users is difficult. As described above, with the above-described related-art technique, measures to suppress spreading are allowed to be taken only after fake information has been spread. Accordingly, there is a facet in which it is difficult to take measures before the spreading of fake information.

Hereinafter, with reference to the accompanying drawings, embodiments of a generation method and an information processing apparatus according to the present disclosure will be described. Each of the embodiments represents only an example or a facet, and such exemplification does not limit ranges of numerical values or functions, a usage scene, or the like. Individual embodiments may be appropriately combined within a range not causing any contradiction in processing content.

### First Embodiment

<System Configuration>

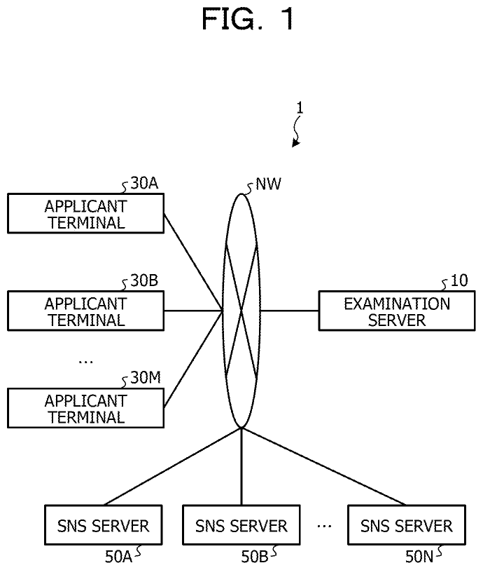

FIG. 1 is a diagram illustrating a configuration example of a cyber insurance examination system. Although it is only an example of a usage scene of user determination, FIG. 1 illustrates an example in which user determination using a probability of a user spreading fake information, for example, a “potential spreading user coefficient”, which will be described later, is applied to examination of a cyber insurance.

A cyber insurance examination system 1 illustrated in FIG. 1 provides examination functions that execute examination related to the insureds who are to subscribe to a cyber insurance contract. Although it is only in a facet, the “cyber insurance” described herein refers to an insurance for dealing with troubles that may occur due to risks such as cyber attacks, use of curation media or social media, or the like.

As illustrated in FIG. 1, the cyber insurance examination system 1 may include an examination server 10, applicant terminals 30A to 30M, and social networking service (SNS) servers 50A to 50N. Hereinafter, in a case where the individual terminals of the applicant terminals 30A to 30M are not necessarily distinguished from each other, the applicant terminals 30A to 30M are referred to as “applicant terminals 30” in some cases. Also, in a case where the individual servers of the SNS servers 50A to 50N are not necessarily distinguished from each other, the SNS servers 50A to 50N are referred to as “SNS servers 50” in some cases.

The examination server 10, the applicant terminals 30, and the SNS servers 50 are communicably coupled to each other via a network NW. For example, the network NW may be an arbitrary type of wired or wireless communication network such as the Internet, a local area network (LAN), or the like.

The examination server 10 is an example of a computer that provides the above-described examination functions. As an embodiment, the examination server 10 may provide the above-described examination functions by causing an arbitrary computer to execute software that implements the above-described examination functions. For example, the examination server 10 may be implemented as a server that provides the above-described examination functions on-premises. Alternatively, the examination server 10 may be implemented as a platform as a service (PaaS) type or a software as a service (SaaS) type application to provide the above-described examination functions as a cloud service. The examination server 10 may correspond to an example of an information processing apparatus.

As part of the examination of the cyber insurance, the above-described examination functions may include a function of determining a suitability of the insured designated by an applicant who applies to a subscription for the cyber insurance contract, a function of determining an insurance premium or a grade for classifying the insurance premium of the insured, and the like.

Hereinafter, as one of the examination functions, an example of an insurance premium determination function that determines an insurance premium of the insured is described. For example, the examination server 10 accepts a subscription request to subscribe to a cyber insurance from any of the applicant terminals 30. For example, the subscription request may include a list of insureds, account information of an SNS used by each insured, and the like. In response to such a subscription request, the examination server 10 uses an application programming interface (API) made public by the SNS servers 50 to collect, for each insured, information such as posts and a profile of the insured as an SNS user. Based on these pieces of information such as posts and a profile, the examination server 10 calculates the premium for each insured person.

Each of the applicant terminal 30 is a terminal device used by an applicant who applies to a subscription for the above-described cyber insurance contract. The “applicant” described herein corresponds to a policyholder of the cyber insurance and may apply to a subscription for the above-described cyber insurance contract on behalf of one or a plurality of insureds. The label “applicant terminal” is only a classification in a facet based on the user of the machine. Neither the type nor the hardware configuration of the computer is limited to a specific type or hardware configuration. For example, the applicant terminal 30 may be implemented by an arbitrary computer such as a personal computer, a mobile terminal device, or a wearable terminal.

Each of the SNS servers 50 is a server device operated by a service provider that provides an SNS. In a facet, each of the SNS server 50 provides various services related to the SNS to a user terminal (not illustrated) in which an application for a client who receives provision of the SNS is installed. For example, the SNS servers 50 may provide a message posting function, a profile function, a quoting function of quoting a post of another SNS user, a follow function of following another SNS user, a reaction function of indicating a reaction such as an impression to a post of another SNS user, and the like.

<Facet of Problem>

With the above-described related art, only users who have experience of spreading fake information in the past are extracted. Thus, in a facet, it is difficult to extract users who have no experience of spreading fake information in the past.

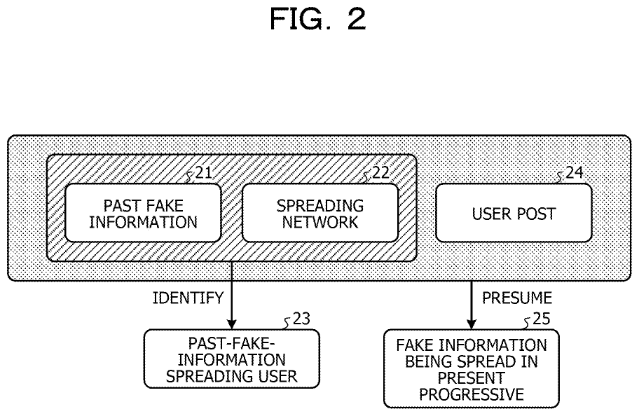

FIG. 2 is a diagram illustrating an extraction example (1) of a fake information spreading user. FIG. 2 illustrates the user extraction executed in the above-described related art. As illustrated in FIG. 2, according to the above-described related art, a past-fake-information spreading user 23 is identified based on past fake information 21 and a spreading network 22.

As the past fake information 21, information verified as incorrect information by a fact check organization and the like may be used. Also, the spreading network 22 may be presumed by searching past records of the SNS. For example, archives of posts of SNS users are collected by using the API made public by the SNS. When following relationships between users who have posted posts corresponding to the past fake information 21 in the archives are searched in time series, a series of users who propagated the past fake information 21 are extracted as the spreading network 22. Out of the users included in such a spreading network 22, specific users, for example, users followed by users who spread posts, users who do not hesitate to spread posts (users who have many posts), and so forth are identified as past-fake-information spreading users 23. For example, a technique to be used to presume the spreading network 22 is described in MATSUNO, et al., “Verifying the impact of user follower composition on the spreadability of SNS posts” (The 35th Annual Conference of the Japanese Society for Artificial Intelligence, 2021).

According to the above-described related art, the past-fake-information spreading users 23 may be identified only at a stage where the fake information is in a spreading state. Such past-fake-information spreading users 23 do not include, out of the users who have no experience of spreading fake information in the past, users with high possibility of spreading fake information sometime, for example, so-called potential spreading users. Thus, according to the above-described related art, even when present-progressive user posts 24 are used in addition to the past fake information 21 and the spreading network 22, only presently progressing and spreading fake information 25 is presumed. Accordingly, it is clear that there is no idea of identifying fake-information potential spreading users in the entirety of the related art including the above-described related art.

<Facet of Problem-Solving Approach>

Thus, according to the present embodiment, in a facet of realizing user determination including determination of the fake-information potential spreading user, a generation function that generates, based on a tendency of topics shared by a group to which the SNS user belongs, information indicating the probability of the SNS user spreading posted fake information is included.

Hereinafter, in some cases, the information indicating the probability of the SNS user spreading fake information may be referred to as a “fake-information potential spreading user coefficient” or simply a “potential spreading user coefficient”. The “potential spreading user coefficient” described herein is a label having a facet in which potential spreading users having no experience of spreading fake information in the past may be included in the category and is a probability that may be generated for each SNS user regardless of whether the user has an experience of actually spreading fake information in the past.

For example, when users who are likely to spread fake information in future, for example, the fake-information potential spreading users are identified and handled, the handling before the spreading of fake information may be realized. From a broad view, since actual harm caused by users who spread fake information is larger than that caused by a user who originally submits fake information, it is apparent that the technical significance of identifying the fake-information potential spreading users is high.

There is a tendency specific to the fake-information potential spreading users even when the users have not spread the fake information in the past. When the users having such a tendency are in an environment in which fake information is likely to be spread, there is a high possibility that fake information is spread.

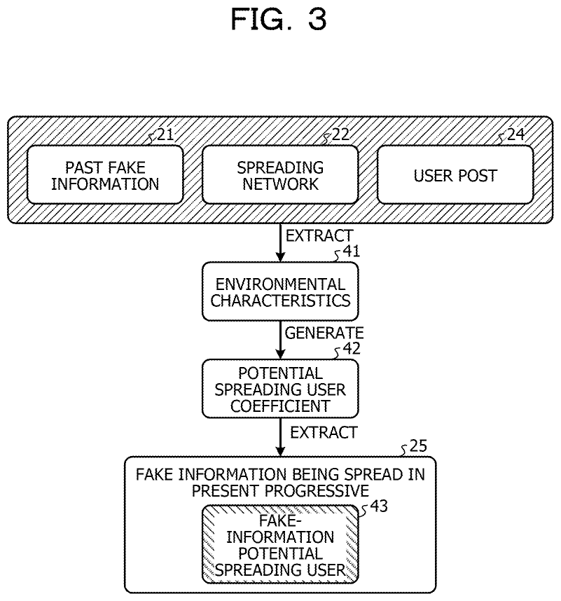

FIG. 3 is a diagram illustrating an extraction example (2) of the fake information spreading user. FIG. 3 illustrates the user extraction realized by the generation function according to the present embodiment. As illustrated in FIG. 3, the above-described generation function extracts, as environmental characteristics 41, a tendency of topics shared by a group to which an SNS user belongs based on the past fake information 21, the spreading network 22, and the present-progressive user posts 24.

Although it is only exemplary, the above-described group may be identified by extracting relations between the users who are in mutually following relationships. Although the details of a method of extracting a tendency of topics shared by such a group will be described later, only as an example, the following items may be extracted as the environmental characteristics 41 of the SNS user. For example, at least one of the following items may be included: an echo chamber immersion index; a relation to a user having an experience of spreading fake information in the past; bias of topics along a timeline; bias of topics of the users in the group; a frequency of posts in the group; and the magnitude of influence of the SNS user in the group.

The above-described generation function generates, from the environmental characteristics 41 of the SNS user, information indicating the probability of the SNS user spreading fake information posted in the SNS, that is, the above-described fake-information potential spreading user coefficient 42.

Although it is only as an example of the user determination, such a potential spreading user coefficient 42 may be used to extract fake-information potential spreading users 43 from SNS users. For example, out of the SNS users, SNS users for which the potential spreading user coefficient 42 exceeds a threshold may be extracted as the fake-information potential spreading users 43. In this way, a countermeasure to suppress the spreading may be executed before the spreading of the fake information. For example, an alert indicating that there is a risk of spreading fake information may be notified to user terminals of the fake-information potential spreading users 43. A message or an icon corresponding to the above-described alert may be displayed in a post of a fake-information potential spreading user 43 or a post in which the post of the fake-information potential spreading user 43 is copied.

In addition, the above-described user determination may be incorporated as part of the above-described examination function. For example, an example in which the premium of the insured is determined is described. In this case, as the potential spreading user coefficient 42 of the insured as the SNS user increases, a higher premium may be set for this insured, or as the potential spreading user coefficient 42 reduces, a lower premium may be set for this insured.

As described above, the generation function according to the present embodiment may quantify the probability of the SNS user spreading fake information based on the tendency of topics shared by the group to which the SNS user belongs. Thus, with the generation function according to the present embodiment, the user determination including the fake-information potential spreading users may be realized.

<Configuration of Examination Server 10>

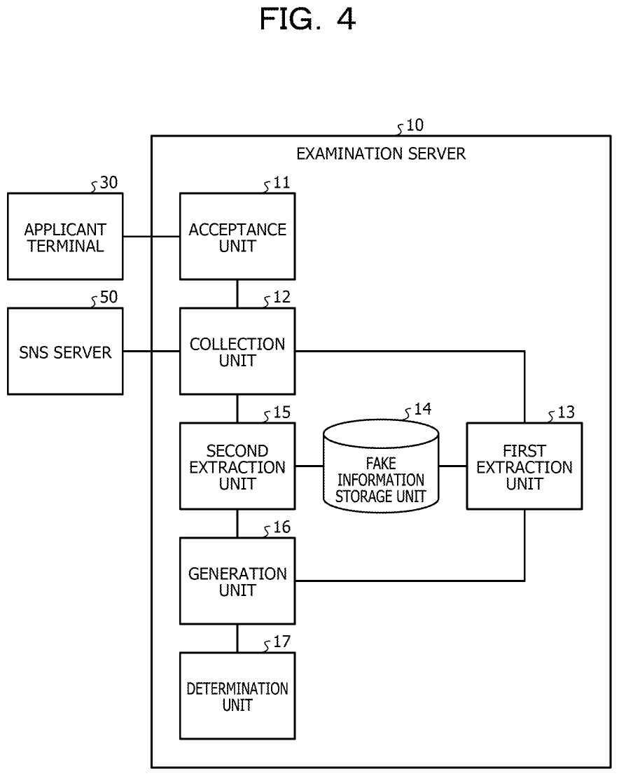

Next, a functional configuration example of the examination server 10 having the examination function according to the present embodiment is described. FIG. 4 is a diagram illustrating the functional configuration example of the examination server 10. FIG. 4 illustrates blocks corresponding to the examination function in which the above-described generation function is packaged. Although FIG. 4 illustrates the entirety of the above-described examination function, this does not conflict with a configuration in which the examination server 10 includes only a functional unit corresponding to the above-described generation function.

As illustrated in FIG. 4, the examination server 10 includes an acceptance unit 11, a collection unit 12, a first extraction unit 13, a fake information storage unit 14, a second extraction unit 15, a generation unit 16, and a determination unit 17.

Functional units such as the acceptance unit 11, the collection unit 12, the first extraction unit 13, the second extraction unit 15, the generation unit 16, and the determination unit 17 are implemented by a hardware processor. Examples of the hardware processor include, for example, a central processing unit (CPU), a microprocessor unit (MPU), a graphics processing unit (GPU), and a general-purpose computing on GPU (GPGPU). The processor reads, in addition to an operating system (OS), a program such as an examination program that implements the above-described examination function from a storage device (not illustrated), such as, for example a hard disk drive (HDD), an optical disk, or a solid-state drive (SSD). The processor then executes the above-described examination program, thereby loading processes corresponding to the above-described functional units on a memory such as a random-access memory (RAM). As a result of execution of the above-described examination program in such a manner, the functional units described above are virtually implemented as the processes. Although the CPU and the MPU are described as examples of the processor herein, the above-described functional units may be implemented by an arbitrary processor which may be of a general-purpose type or a dedicated type. In addition to this, the functional units described above or a subset of the functional units may be implemented by hard wired logic such as an application-specific integrated circuit (ASIC) or a field-programmable gate array (FPGA).

A storage unit such as the fake information storage unit 14 may be implemented as follows. For example, the above-described storage unit may be implemented as an auxiliary storage device such as an HDD, an optical disc, or an SSD or may be implemented by allocating part of a storage area of an auxiliary storage device.

The acceptance unit 11 is a processing unit that accepts various requests from an external device. Although it is only exemplary, the acceptance unit 11 accepts a subscription request to subscribe to a cyber insurance from the applicant terminal 30. Such a subscription request may include a list of insureds, account information of an SNS used by each insured, and the like.

The collection unit 12 is a processing unit that collects SNS usage statuses. Although it is only exemplary, in a case where the subscription request to subscribe to the cyber insurance is accepted by the acceptance unit 11, the collection unit 12 executes the following processing. For example, the collection unit 12 uses the API made public by the SNS server 50 to collect, from the SNS server 50, various types of information such as a post, a group, the number of followers, and a profile corresponding to the account information of the SNS used by each of the insured as the SNS usage statuses.

The first extraction unit 13 is a processing unit that extracts personal characteristics of the SNS user. The “personal characteristics” described herein may be calculated from the degree of suspicion about the reliability of information submitted by the SNS user (hereafter, “unreliability”). For example, the “unreliability” may be calculated based on at least one of a personality tendency, an emotional tendency, a reputation, a quality of information submission, a reaction of another SNS user to a post of the SNS user, and the ratio of spreading experiences of past fake information to the total number of submissions. The “experience” described herein corresponds to an example of history.

The above-described “personality tendency” may be calculated by using an API of a personality analysis service that determines, from input text, the characteristics of a person who has written the text with a post of the SNS user set as an argument.

A personality analysis service outputs a ratio, for example, a percentage or the like conforming to each personality category from linguistic features, psychological action, relativity, targets of interest, and ways to use words. The personality analysis service is provided by a plurality of venders, and an arbitrary personality analysis service may be used.

Although it is only exemplary, examples of such personality categories include uncompromising, anger, and sensitivity to stress and also include cautiousness and imagination.

Out of these personality categories, the former has a positive correlation with unreliability whereas the latter have a negative correlation with unreliability. Thus, the latter is inverted by subtracting from the modulus, for example, 100 in the case of percentage, and the inverted value is used to calculate the personality tendency.

The ratio of the personality category is not necessarily a value obtained from a single post but may be a statistic such as a representative value, for example, an average value or a median value obtained by applying a plurality of posts made by the SNS user to the personality analysis service. For example, in the calculation of the representative value, all the posts of the SNS user may be applied to the personality analysis service, or a subset of the posts of the SNS user, for example, posts of the SNS user narrowed down to those made within a specific period of time beginning from a time tracing back from the calculation time may be applied to the personality analysis service.

By applying a statistical process, for example, an arithmetic mean or a weighted mean to the representative values of the ratios obtained for respective personality categories, the personality tendency of the SNS user may be calculated.

The above-described “emotional tendency” may be evaluated by measuring an emotional word usage ratio in the entirety of the posts of the SNS user. This measurement may be performed by comparing the posts of the SNS user with an emotional word dictionary in which expressions of emotional words are listed. Although it is only exemplary, in a case where 10-level evaluation is performed, the emotional tendency of “1” may be output in a case where the emotional word use rate is 10%, and the emotional tendency of “6” may be output in a case where the emotional word use rate is 60%. Since the emotional word usage rate increases as the value of such an emotional tendency increases, a person may be evaluated as an emotional person as the value of the emotional tendency increases.

Although the example in which the emotional tendency is calculated by comparing the posts of the SNS user with the emotional word dictionary has been described herein, the emotional tendency may be calculated by using the above-described personality analysis service. For example, “emotional analysis” is also included in one of the above-described APIs of the personality analysis service, and the degrees of emotions of “joy”, “anger”, “hate”, “loneliness”, and “fear” may be obtained. For any of these emotions, when the degree of the emotion is large, it may be identified that there is an aspect of being emotional. Thus, a statistic of the degree of each emotion, for example, an arithmetic mean or a weighted mean may be calculated as the emotional tendency.

The above-described “reputation” may be calculated by executing a negative-positive analysis for the posts of the SNS user. For example, the negative-positive analysis using a polarity dictionary is described as an example. The “polarity dictionary” described herein refers to a dictionary in which a score corresponding to a positive or negative polarity is defined for each word. For example, the above-described score is represented in a numerical range from −1 to 1. Although it is only in a facet, the negative polarity increases as the polarity approaches −1 whereas the positive polarity increases as the polarity approaches +1.

In this case, the first extraction unit 13 separates the posts of the SNS user sentence-by-sentence and word-by-word and obtains the polarity value for each word through comparison with the polarity dictionary. The first extraction unit 13 performs scoring by summing the scores in units of sentences and then performs scoring for the entirety of the text. Thus, the total score of the entirety of the posts may be obtained. In a case where such the sign of the total score of the entirety of the posts is negative, as the absolute value of the total score increases, the value of the reputation is calculated to be greater. Meanwhile, in a case where the sign of the total score is positive, as the absolute value of the total score increases, the value of the reputation is calculated to be smaller.

Although the example in which the reputation is calculated by using the negative-positive analysis has been described herein, the reputation may be calculated by using the above-described personality analysis service. For example, “reputation analysis” is also included in one of the APIs of the above-described personality analysis service, and a determination result indicating the position of the input text out of “positive”, “negative”, and “neutral” may be obtained. For example, in a case of “negative”, the value of the reputation may be calculated to be “large”, in a case of “neutral”, the value of the reputation may be calculated to be “intermediate”, and in a case of “positive”, the value of the reputation may be calculated to be “small”.

The above-described “quality of information submission” refers to basic literacy such as a literal error/missing character, an input error, and a misuse of a word and may be calculated based on at least one of, for example, the frequency of the literal error/missing character, the frequency of unstable representation, and the frequency of the misuse of a word.

For example, a machine learning model is trained for which correct text data and incorrect text data with literal errors are set as training data, to which text data is input, and which outputs the frequency of the literal error, for example, the number of times of the occurrences of the literal error/the total number of words. Although it is only as an example of the machine learning model, for example, a neural network such as a recurrent neural network (RNN) may be used.

When the posts of the SNS user is input to such a trained machine learning model, a frequency of the literal error may be obtained. For example, it may be said that, as the frequency of the literal error increases, the quality of information submission reduces. Accordingly, as the frequency of the literal error increases, the lowness of the quality of information submission may be calculated to be greater.

Although the machine learning model that outputs the frequency of the literal error has been described as the example herein, the frequency of the literal error may be obtained by using an existing text proofreading tool. Although, only as an example, the literal error is described as the example herein, the input error and the misuse of a word may also be obtained in a similar manner. For example, in a case where the frequency is obtained for each of the literal error/missing character, the input error, and the misuse of a word, a representative value, for example, the arithmetic mean, the weighted mean, or the like of the three frequencies may be calculated. The posts of the SNS user used herein may be all or a subset of the posts made by the SNS user.

The above-described “reaction of another SNS user to a post of the SNS user” may be calculated by executing the negative-positive analysis for posts of the other SNS user who quotes or copies the post of the SNS user. Also in this case, in the case where the sign of the total score of the entirety of the posts is negative, and as the absolute value of the total score increases, the value of the reaction may be calculated to be greater, whereas, in the case where the sign of the total score is positive, as the absolute value of the total score increases, the value of the reaction may be calculated to be smaller.

The above-described “ratio of a spreading experience of past fake information to the total number of submissions” may be calculated as follows. For example, the first extraction unit 13 compares the posts of the SNS user with the fake information storage unit 14. Although it is only exemplary, the fake information storage unit 14 stores each piece of the past fake information 21 in a state in which the piece of the past fake information 21 is associated with an address such as a uniform resource locator (URL), the title of the fake information, and the like that identify the piece of the past fake information. In addition to such past fake information 21, the fake information storage unit 14 may further store the spreading network 22 corresponding to the past fake information 21.

In more detail, for each post of the SNS user, the first extraction unit 13 determines whether the text included in the post includes the title or address of the fake information stored in the fake information storage unit 14. At this time, in a case where the title or address of the fake information is included, the number of times of the spreading experience of the past fake information is incremented. After such determination has been repeated for all the posts of the SNS user or the posts traced back to a specific period from the latest, the first extraction unit 13 may calculate the above-described ratio by dividing the number of times of the spreading experience of the past fake information by the total number of submissions.

In a case where a plurality of items out of the personality tendency, the emotional tendency, the reputation, the quality of information submission, the reaction of another SNS user to a post of the SNS user, and the ratio of spreading experiences of past fake information to the total number of submissions are extracted, a representative value, for example, an average value or a median value may be extracted as a personal characteristic by executing normalization for adjusting mutual scales of the plurality of items.

As a facet, since the personal characteristics extracted in this manner are determined based on the unreliability, the SNS user may be evaluated as a person who is more likely to be deceived by fake information as the value of the personal characteristics increases.

The personal characteristics may include influence of information submission. The influence may be calculated from, for example, at least one of the following: the total number of times that the posts of the SNS user have been quoted in the past; the number of followers; the number of reactions of other SNS users (such as the number of times that a specific icon is clicked); the number of comments from other SNS users; the total number of submissions of the SNS user; the number of replies; and, in addition, a numerical value group which is provided by the SNS and which is able to be obtained by an API or the like.

The second extraction unit 15 is a processing unit that extracts the environmental characteristics of the SNS user. The“environmental characteristics” described herein refer to a tendency of topics shared by a group to which the SNS user belongs. For example, the “environmental characteristics” may be calculated based on, for example, at least one of the following: an echo chamber immersion index; a relation to a user having an experience of spreading fake information in the past; bias of topics along a timeline; bias of topics of the users in the group; a frequency of posts in the group; and the magnitude of influence of the SNS user in the group.

The above-described “echo chamber immersion index” refers to a numerical value obtained by quantifying the degree to which the SNS user is immersed in a so-called echo chamber phenomenon.

Although it is only exemplary, the echo chamber immersion index may be calculated by quantifying the bias of the group to which the SNS user belongs from the entire SNS based on a timeline of the SNS, following relationships, and posts in which the SNS user quotes a post of another SNS user. To calculate such an echo chamber immersion index, techniques described in TORIUMI, Fujio, SAKAKI, Takeshi, YOSHIDA, Mitsuo, “Social Emotions Under the Spread of COVID-19 Using Social Media”, Short Paper of Journal of The Japanese Society for Artificial Intelligence, Vol. 35, No. 4, p. F-K45, 1-7, Jul., 2020 (hereinafter, referred to as TORIUMI) may be used. TORIUMI quotes S. Kullback and R. A. Leibler, “On Information and Sufficiency.”, The Annals of Mathematical Statistics, Vol. 22, No. 1, pp. 79-86, March, 1951.

For example, the second extraction unit 15 obtains posts appearing in the timeline of the SNS user by using the API of the SNS. When it is assumed that the ratio of users belonging to a community (group) c is Pt (c) and the ratio of users belonging to the community c out of users who have spread is Pb (c), the Kullback-Leibler divergence (KL-divergence) is calculated in accordance with the following expression (1).

$${D}_{KL} = {\sum }_{c} {P}_{b} ( c ) log ( \frac{{P}_{b} ( c )}{{P}_{t} ( c )} ) \qquad ( 1 )$$

The Kullback-Leibler divergence is 0 when two distributions which are a distribution of the community to which the users belong and a distribution of the entire SNS completely coincide with each other. The Kullback-Leibler divergence increases as the difference between the two distributions increases. For example, it may be said that as the Kullback-Leibler divergence increases, the group is biased more. Thus, it may be evaluated that, as the Kullback-Leibler divergence reduces, a fake-information spreading risk level reduces, and, in contrast, it may be evaluated that, as the Kullback-Leibler divergence increases, the fake-information spreading risk level increases.

A method of calculating the echo chamber immersion index is not limited to the technique described in above-referred TORIUMI. As another example, the echo chamber immersion index may also be calculated according to a model described in SASAHARA, K., CHEN, W., PENG, H. et al., “Social influence and unfollowing accelerate the emergence of echo chambers.” Journal of computer Social Science, 4, 381-402 (2021) (hereinafter, referred to as SASAHARA).

The model described in above-referred SASAHARA assumes a user who makes some comment that seems to divide into two poles in a certain theme, for example, political ideology or the like. However, in the above-described model, since the users are randomly arranged, the bias is not assumed from the beginning.

For a specific user group that speaks such a specific topic, change in the user's opinion may be calculated in the following three elements: tolerance (a confidence limit distance of the user); social influence (the number of relations and the strength of influence); and the frequency of unfollowing.

Thus, a dynamic model has been proposed under the assumption that there are information displayed on the timeline due to the relation to another user and information in which the user is exposed, and the user gradually changes his/her opinion by unfollowing or it.

According to the model described in above-referred SASAHARA, the echo chamber immersion index may be calculated by using at least the frequency of unfollowing. The echo chamber immersion index may also be calculated by using the social influence or the tolerance as an arbitrary option. In this case, the function the criterion variable of which is the echo chamber immersion index may be an arbitrary function that includes the frequency of unfollowing, the social influence, and the tolerance in the explanatory variable. In a case where either one of the frequency of unfollowing and the social influence is 0, the echo chamber immersion index may be set to 0.

Although it is only exemplary, the above-described “frequency of unfollowing” may be calculated as follows. For example, in the API of the SNS, a follow list in which IDs of other SNS users followed by the SNS user are listed may be collected as an SNS usage status. Thus, when the follow lists of the same SNS user in time series are obtained, two follow lists obtained in time series may be compared with each other. At this time, it may be identified that the ID of another SNS user who is present in the previously obtained follow list out of the two follow lists and absent in the subsequently obtained follow list out of the two follow lists has been unfollowed by the SNS user. When the number of cases of such unfollowing is summarized and the number of cases of unfollowing per unit time is calculated based on the time elapsed between the two follow lists, the frequency of unfollowing may be calculated.

Although it is only exemplary, the above-described “social influence” may be calculated as follows. The social influence may be calculated from, for example, at least one of the following: the total number of times that the posts of the SNS user have been quoted in the past; the number of followers; the number of reactions of other SNS users (such as the number of times that a specific icon is clicked); the number of comments from other SNS users; the total number of submissions of the SNS user; the number of replies; and, in addition, a numerical value group which is provided by the SNS and which is able to be obtained by an API or the like.

Although it is only exemplary, the above-described “tolerance” may be calculated as follows. For example, when a case where the theme is political ideology is taken as an example, from a facet of distributing the opinions of the SNS users between the interval [−1, +1], the opinions of the SNS users are distributed with two axes of the tendencies of the opinions of the users determined in which, for example, the opinion of the SNS user is closer to either a conservative axis or a liberal axis. For example, a machine learning model is trained for which the tolerance and text data are set as training data, to which the text data is input, and which outputs the tolerance. When the posts of the SNS user is input to such a trained machine learning model, the tolerance may be calculated.

From a facet of obtaining “how much influence there is as compared with the overall average, whether the frequency is high”, the frequency of unfollowing and the social influence may be obtained from statistic of active SNS users, out of all the users, whose account is not left unattended. Although determination of whether it is active may be made by an arbitrary method, it may be realized by, for example, whether posting or login is performed within a specific period, for example, one month.

Although it is only exemplary, expression (2) below may be used as an example of a calculation expression of the echo chamber immersion index. With the echo chamber immersion index calculated by expression (2) below, as the value of the echo chamber immersion index increases, the potential spreading user coefficient also increases.

(Frequency of unfollowing of certain user/Average frequency of unfollowing of entire SNS)×(Social influence of certain user/Average social influence of entire SNS)×|Tolerance| (2)

The above-described “relation to a user having an experience of spreading fake information in the past” may be obtained by counting the number of persons having the experience of spreading fake information in the past out of other SNS users having following relationships, with the SNS user, as followers or followees. Although the followers or the followees exemplify following relationships herein, the following relationships may be mutual following.

Although it is only exemplary, the above-described “bias of topics of the users in the group” may be calculated as follows. For example, the second extraction unit 15 analyzes to what degree other SNS users followed by the SNS user or the followers of the SNS user tend to share the same topic.

In more detail, the second extraction unit 15 collects archives of posts of other SNS users followed by the SNS user, decomposes the posts into words by a morphological analysis, and extracts words of frequent occurrence such as independent words including, for example, nouns, adjectives, and verbs. At this time, under a finding that the SNS user is placed in an information environment with more biased opinions as the ratio of appearance of a specific word of frequent occurrence increases, the second extraction unit 15 calculates so as to increase the value of the above-described “bias of topics of the users in the group” as the ratio of appearance of the specific frequent word increases. The above-described analysis may be executed over a certain period of time. Thus, whether the bias is maintained in the environment may be checked. For example, as the bias is observed more continuously, the likelihood of the information environment of the SNS user being biased may be further increased.

In addition, the above-described “bias of topics of the users in the group” may also be calculated by key phrase extraction. In this case, EmbedRank may be used as an example of an algorithm for the key phrase extraction. For example, candidate phrases are extracted from the text based on the information on the part of speech. Vectors of the text and each phrase are obtained by using text embedding. Candidate phrases are ranked by using similarity to the embedding vector of the text, and key phrases are determined. Each time the finally ranked key phrase is duplicated in a topic within a range in which there are following relationships with the SNS user, one is counted. As such a count number increases, it may be said that the fake-information spreading risk level increases.

Although the example has been described in which the above-described “bias of topics of the users in the group” is calculated by, for example, the key phrase extraction herein, the above-described “bias of topics of the users in the group” may be calculated by using the above-described personality analysis service. For example, a “keyword extraction” is also included in one of the APIs of the above-described personality analysis service, and important keywords and phrases appearing in the text may be extracted. Also in this case, by counting the degree of duplication, the above-described “bias of topics of the users in the group” may be calculated.

Although it is only exemplary, the above-described “frequency of posts in the group” may be calculated as follows. For example, the second extraction unit 15 calculates, from the archive of posts of the SNS user, the frequency with which messages are exchanged between the SNS user and members in the group per specific period of time. As such a frequency increases, it may be said that the fake-information spreading risk level increases.

Although it is only exemplary, the above-described “magnitude of influence of the SNS user in the group” may be calculated as follows. The second extraction unit 15 may calculate the magnitude of influence based on, for example, at least one of the following: the total number of times that the post of the SNS user has been quoted in the past; the number of followers; the number of reactions of other SNS users (such as the number of times that a specific icon is clicked); the number of comments from other SNS users; the total number of submissions of the SNS user; the number of replies; and, in addition, a numerical value group which is provided by the SNS and which is able to be obtained by an API or the like.

The generation unit 16 is a processing unit that generates the fake-information potential spreading user coefficient of the SNS user. Although it is only exemplary, the generation unit 16 may calculate the fake-information potential spreading user coefficient based on the environmental characteristics extracted by the second extraction unit 15. At this time, the generation unit 16 may also calculate the fake-information potential spreading user coefficient based on the personal characteristics extracted by the first extraction unit 13 in addition to the above-described environmental characteristics.

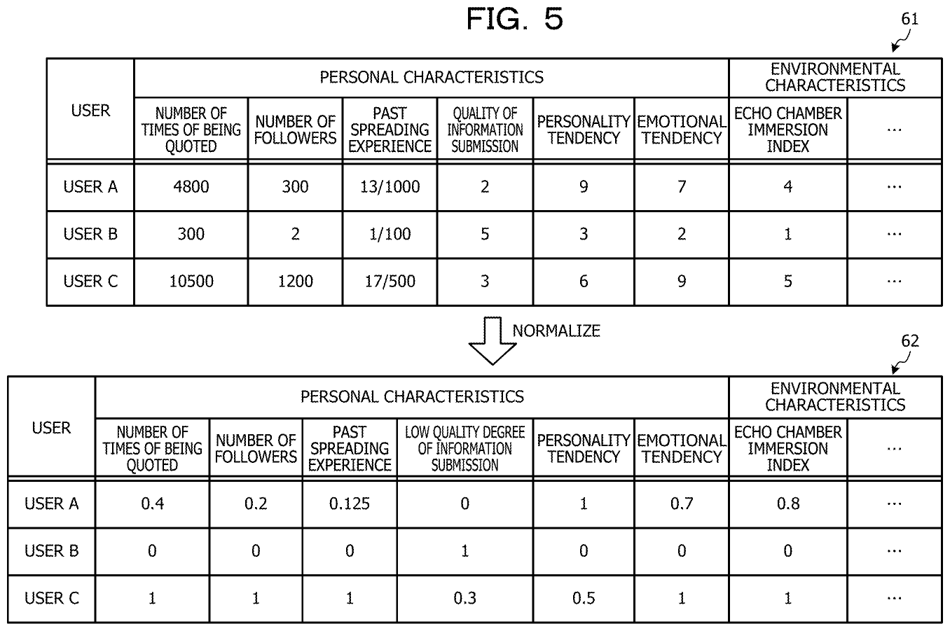

FIG. 5 is a diagram illustrating an example of the extraction of the personal characteristics and the environmental characteristics. FIG. 5 illustrates extraction results of the personal characteristics and the environmental characteristics for each of three SNS users A, B, and C corresponding to respective three insureds. Although FIG. 5 illustrates an example in which the “NUMBER OF TIMES OF BEING QUOTED”, the “NUMBER OF FOLLOWERS”, the “PAST SPREADING EXPERIENCE”, the “QUALITY OF INFORMATION SUBMISSION”, the “PERSONALITY TENDENCY”, and the “EMOTIONAL TENDENCY” are extracted as examples of the personal characteristics, this is merely exemplary and does not conflict with extraction of another personal characteristic. Although FIG. 5 illustrates an example in which the “ECHO CHAMBER IMMERSION INDEX” is extracted as an example of the environmental characteristics, this is merely exemplary and does not conflict with extraction of another environmental characteristic.

As illustrated in FIG. 5, extraction results 61 of the personal characteristics extracted by the first extraction unit 13 and the environmental characteristics extracted by the second extraction unit 15 are subjected to normalization for unifying numerical ranges between the individual personal characteristics and between the individual environmental characteristics. At this time, normalization is executed that maintains the magnitude ratios between the SNS users in the same elements of the personal characteristics or the same elements of the environmental characteristics. Through such normalization, extraction results 62 of the normalized personal characteristics and environmental characteristics are obtained. For example, referring to the example illustrated in FIG. 5, all of the “NUMBER OF TIMES OF BEING QUOTED”, the “NUMBER OF FOLLOWERS”, the “PAST SPREADING EXPERIENCE”, the “QUALITY OF INFORMATION SUBMISSION”, the “PERSONALITY TENDENCY”, the “EMOTIONAL TENDENCY”, and the “ECHO CHAMBER IMMERSION INDEX” are normalized to a numerical range from 0 to 1.

By using the extraction results 62 of the personal characteristics and the environmental characteristics that have been normalized as described above, the fake-information potential spreading user coefficient is generated for each of the three SNS users A, B, and C.

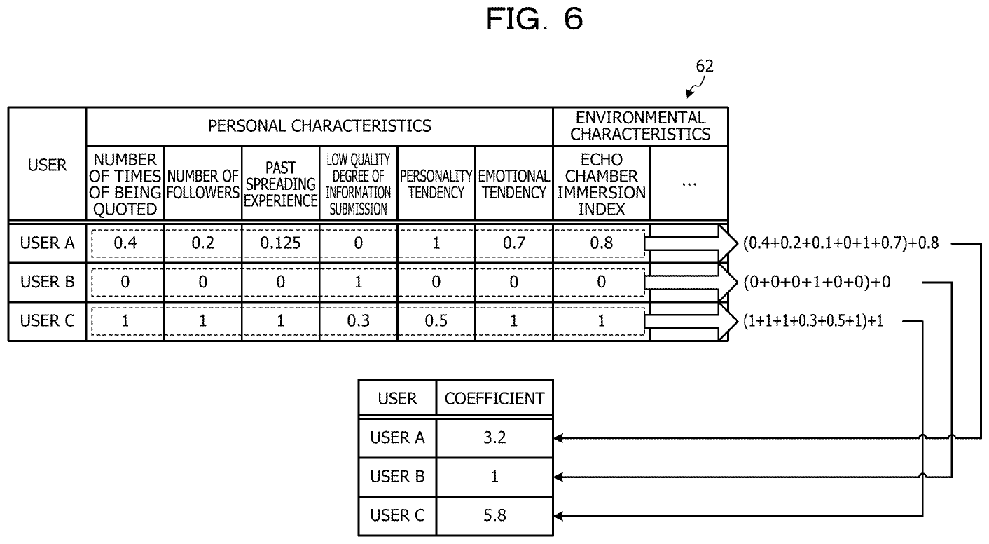

Although it is only exemplary, the generation unit 16 may generate the fake-information potential spreading user coefficient by performing addition, a so-called summing, of the personal characteristics and the environmental characteristics. FIG. 6 is a diagram illustrating a generation example (1) of the fake-information potential spreading user coefficient. In the example of the SNS user A illustrated in FIG. 6, the number of times of being quoted of “0.4”, the number of followers of “0.2”, the past spreading experience of “0.1 (0.125 is rounded off)”, the low-quality degree of information submission of “0”, the personality tendency of “1”, the emotional tendency of “0.7”, and the echo chamber immersion index of “0.8” are added up. For example, by the calculation of (0.4+0.2+0.1+0+1+0.7+0.8), the fake-information potential spreading user coefficient of the SNS user A is calculated to be “3.2”. Although the values of the personal characteristics and the environmental characteristics are different, the fake-information potential spreading user coefficient of the SNS user B may be calculated to be “1” and the fake-information potential spreading user coefficient of the SNS user C may be calculated to be “5.8” by the similar calculation.

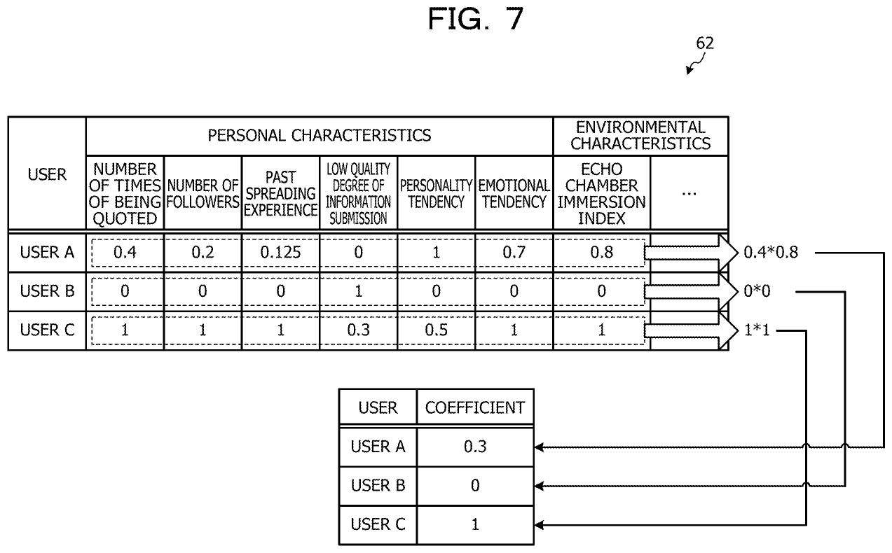

As another example, the generation unit 16 may generate the fake-information potential spreading user coefficient also by performing multiplication of the personal characteristics and the environmental characteristics. FIG. 7 is a diagram illustrating a generation example (2) of the fake-information potential spreading user coefficient. In the example of the SNS user A illustrated in FIG. 7, the number of times of being quoted of “0.4”, the number of followers of “0.2”, the past spreading experience of “0.1 (0.125 rounded off to the one decimal place)”, the low quality degree of information submission of “0”, the personality tendency of “1”, and the emotional tendency of “0.7” are added up and normalized to a numerical range from 0 to 1. Thus, the representative value of the personal characteristics of “0.4” is obtained. When the representative value of the personal characteristics of “0.4” and the representative value of the environmental characteristics of “0.8” obtained as described above are multiplied, the fake-information potential spreading user coefficient of the SNS user A may be calculated to be “0.3 (0.32 rounded off to the one decimal place)”. Although the values of the personal characteristics and the environmental characteristics are different, the fake-information potential spreading user coefficient of the SNS user B may be calculated to be “0” and the fake-information potential spreading user coefficient of the SNS user C may be calculated to be “1” by the similar calculation.

Although examples of addition and multiplication are illustrated in FIGS. 6 and 7, a statistical process such as an arithmetic mean or a weighted mean may be executed when the representative value of the individual elements of the personal characteristics or the representative value of the individual elements of the environmental characteristics is calculated. Also, when the potential spreading user coefficient is calculated, a statistical process such as an arithmetic mean or a weighted mean may be executed between the representative value of the personal characteristics and the representative value of the environmental characteristics.

The determination unit 17 is a processing unit that determines the premium of the insured. Although it is only exemplary, the determination unit 17 determines the premium based on the fake-information potential spreading user coefficient generated by the generation unit 16. For example, as the potential spreading user coefficient 42 of the insured as the SNS user increases, the determination unit 17 may set a higher premium for this insured, or as the potential spreading user coefficient 42 reduces, the determination unit 17 may set a lower premium for this insured. For example, in addition to the basic premium serving as the base, a penalty extra fee may be charged in accordance with the potential spreading user coefficient. Numerical examples are as follows: in addition to the monthly basic premium, the extra fee of 2,000 yen is charged to the insured having a potential spreading user coefficient of greater than or equal to 0.75; and in addition to the monthly basic premium, the extra fee of 1,000 yen is charged to the insured having a potential spreading user coefficient of greater than or equal to 0.5 and smaller than 0.75. The extra fee is not charged to the insured having a potential spreading user coefficient of smaller than 0.5. When such a charging system is applied to the example illustrated in FIG. 7, the extra fee is not charged to the insured corresponding to the SNS user A and the insured corresponding to the SNS user B, whereas the extra fee of 2000 yen per month is charged to the insured corresponding to the SNS user C.

Although the example in which the premium is determined based on the potential spreading user coefficient has been described herein, the premium may be graded based on the potential spreading user coefficient or the suitability of the insured may be determined based on the potential spreading user coefficient. For example, to determine the suitability of the insured, the insured may be determined to be unsuitable for the subscription in a case where the potential spreading user coefficient is greater than or equal to a threshold whereas the insured may be determined to be suitable for the subscription in a case where the potential spreading user coefficient is smaller than the threshold.

<Flow of Process>

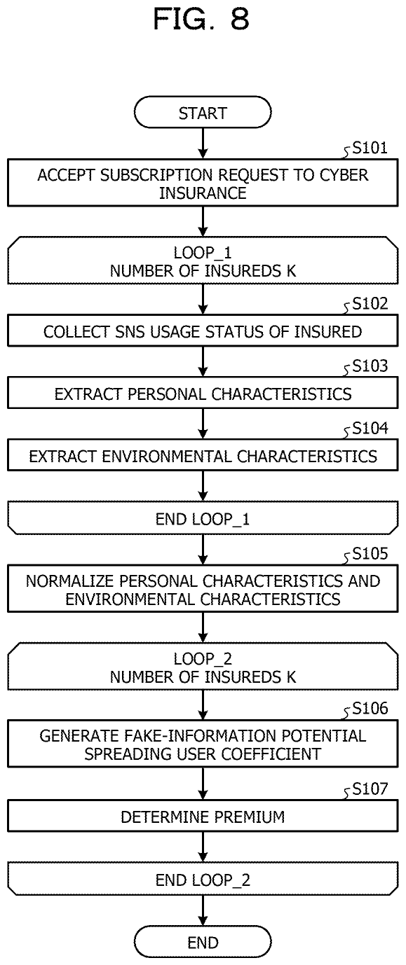

FIG. 8 is a flowchart illustrating a procedure of a generating process. Although it is only exemplary, the process illustrated in FIG. 8 may be started in a case where a subscription request to the cyber insurance has been accepted from the applicant terminal 30.

As illustrated in FIG. 8, when the subscription request to the cyber insurance is accepted (step S101), a loop process loop_1 in which processes from step S102 to step S104 are repeated is executed the number of times corresponding to a number of the insureds K designated in the list of the insureds. Although an example in which the processes from step S102 to step S104 are executed as loop_1 is illustrated in FIG. 8, the processes from step S102 to step S104 are not necessarily executed in series and may be executed in parallel for each of K insureds.

For example, the collection unit 12 uses the API of the SNS to collect, from the SNS server 50, various types of information such as the posts, the group, the number of followers, and the profile corresponding to the account information of the SNS used by the insured as the SNS usage status (step S102).

Next, the first extraction unit 13 extracts the personal characteristics of the SNS user (the insured) based on the SNS usage status collected in step S102, the past fake information 21, the title of the past fake information, the address, the spreading network 22, and the like (step S103).

The second extraction unit 15 extracts the environmental characteristics of the SNS user based on the SNS usage status collected in step S102, the past fake information 21, the title of the past fake information, the address, the spreading network 22, and the like (step S104).

When loop_1 is repeated, the personal characteristics and the environmental characteristics are extracted for each insured.

After that, the generation unit 16 normalizes the personal characteristics extracted for each insured in step S103 and the environmental characteristics extracted for each insured in step S104 (step S105).

After that, the generation unit 16 executes a loop process loop_2 in which processes of step S106 and step S107 are repeated the number of times corresponding to the number of insureds K. Although an example in which the processes of step S106 and step S107 are executed as the loop_2 is illustrated in FIG. 8, the processes of step S106 and step S107 are not necessarily executed in series and may be executed in parallel for each of K insureds.

For example, the generation unit 16 generates the fake-information potential spreading user coefficient of the insured based on the personal characteristics and the environmental characteristics normalized in step S105 (step S106). Based on the potential spreading user coefficient generated in step S106, the determination unit 17 determines the premium of the insured (step S107).

When loop_2 is repeated, the premium for each insured is determined.

<Facet of Effects>

As described above, the examination server 10 according to the present embodiment generates the information indicating the probability of the SNS user spreading the posted fake information based on the tendency of topics shared by the group to which the SNS user belongs. Thus, with the examination server 10 according to the present embodiment, the user determination including the fake-information potential spreading users may be realized.

### Second Embodiment

Although the embodiment relating to the apparatus of the disclosure has been described hitherto, the present disclosure may be carried out in various different forms other than the above-described embodiment. Another embodiment of the present disclosure will be described below.

<Application Example of Usage Scene>

Although the example in which the usage scene of incorporating the above-described generation function into the examination of the cyber insurance has been described according to the above-described first embodiment, of course, the above-described generation function may be applied to other usage scenes.

For example, the above-described generation function may be applied to marketing applications, for example, promotion of new products. For example, in a case of application to promotion of a new product, a promoting side wants a person who has a high influence, even not as high as that of an influencer, to use a sample product. However, if possible, the promoting side desires to avoid a situation in which the promoting side asks a person who has a high fake-information potential spreading user coefficient to use the sample product. For example, user determination as follows may be made: a request to an SNS user whose potential spreading user coefficient is greater than or equal to a threshold, for example, 0.5 is prohibited, whereas a request to an SNS user whose potential spreading user coefficient is smaller than the threshold is allowed. In this way, the fake-information potential spreading user may be excluded from monitors of a new product or the like.

The above-described generation function may also be applied to a warning function of the SNS. Although it is only exemplary, a presentation form of the post of the SNS user may be changed in accordance with the fake-information potential spreading user coefficient. For example, for a post of an SNS user having a potential spreading user coefficient of greater than or equal to 0.75, an alert of the fake-information spreading risk level of “high”, for example, full warning is displayed. For a post of an SNS user having a potential spreading user coefficient of greater than or equal to 0.25 and smaller than 0.75, an alert of the fake-information spreading risk level of “intermediate”, for example, partial warning is displayed. For a post of an SNS user having a potential spreading user coefficient of smaller than 0.25, an alert of the fake-information spreading risk level of “low”, for example, attention attracting (provision of small information) level is displayed. In this way, spreading of fake information in the SNS may be suppressed in advance.

<Distribution and Integration>

The individual elements of the illustrated apparatus are not necessarily physically configured as illustrated. For example, the specific form of the distribution and integration of the apparatus is not limited to the illustrated form, and all or part of the apparatus may be configured in arbitrary units in a functionally or physically distributed or integrated manner depending on various loads, usage statuses, and the like. For example, the acceptance unit 11, the collection unit 12, the first extraction unit 13, the second extraction unit 15, the generation unit 16, or the determination unit 17 may be coupled through a network, as an external device of the examination server 10. The acceptance unit 11, the collection unit 12, the first extraction unit 13, the second extraction unit 15, the generation unit 16, or the determination unit 17 may be included in a separate apparatus and may be coupled through a network for cooperation so as to implement the functions of the examination server 10.

<Hardware Configuration>

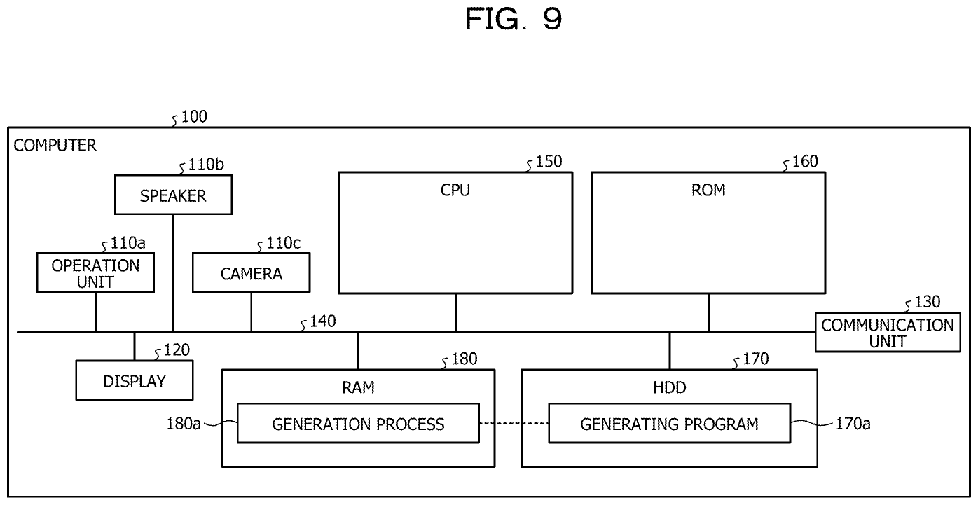

The various processes described in the above embodiments may be implemented when a program prepared in advance is executed by a computer such as a personal computer or a workstation. An example of the computer that executes a generating program having similar functions to those of the first embodiment and the second embodiment will be described below with reference to FIG. 9.

FIG. 9 is a diagram illustrating a hardware configuration example. As illustrated in FIG. 9, a computer 100 includes an operation unit 110a, a speaker 110b, a camera 110c, a display 120, and a communication unit 130. The computer 100 also includes a CPU 150, a read-only memory (ROM) 160, an HDD 170, and a RAM 180. These components 110 to 180 are coupled to each other via a bus 140.

As illustrated in FIG. 9, the HDD 170 stores a generating program 170a which performs the functions similar to those of the acceptance unit 11, the collection unit 12, the first extraction unit 13, the second extraction unit 15, the generation unit 16, and the determination unit 17 described in the above-described first embodiment. Similarly to the individual elements of the acceptance unit 11, the collection unit 12, the first extraction unit 13, the second extraction unit 15, the generation unit 16, and the determination unit 17 illustrated in FIG. 4, the generating program 170a may be provided integrally or separately. For example, not all of the data described in the first embodiment is necessarily stored in the HDD 170. It is sufficient that data used for the processes be stored in the HDD 170.

Under such an environment, the CPU 150 loads the generating program 170a from the HDD 170 onto the RAM 180. As a result, the generating program 170a functions as a generation process 180a as illustrated in FIG. 9. The generation process 180a loads various types of data read from the HDD 170 in an area allocated to the generation process 180a in a storage area included in the RAM 180 and executes various processes by using the loaded various types of data. For example, a process executed by the generation process 180a may include the process illustrated in FIG. 8 and the like as an example. Not all the processing units described in the first embodiment above necessarily operate on the CPU 150. It is sufficient that processing units corresponding to the processes to be executed be virtually implemented.

The above-described generating program 170a is not necessarily initially stored in the HDD 170 or the ROM 160. For example, the generating program 170a is stored in a “portable physical medium” (computer-readable recording medium) such as a flexible disk called an FD, a compact disc (CD)-ROM, a Digital Versatile Disc (DVD) disk, a magneto-optical disk, or an integrated circuit (IC) card to be inserted into the computer 100. The computer 100 may obtain the generating program 170a from the portable physical medium and execute the obtained generating program 170a. The generating program 170a is stored in another computer, a server device, or the like coupled to the computer 100 via a public network, the Internet, a LAN, a wide area network (WAN), or the like. The generating program 170a stored in this manner may be downloaded to the computer 100 and executed.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A generation method, comprising:
extracting, by a computer, a tendency of topics shared by a group to which a user of a social networking service belongs; and
generating information that indicates, based on the tendency of topics, a probability of the user spreading posted fake information.

2. The generation method according to claim 1, further comprising:
extracting, as the tendency of topics, an echo chamber immersion index obtained by quantifying a degree to which the user is immersed in an echo chamber phenomenon.

3. The generation method according to claim 2, further comprising:
extracting the echo chamber immersion index based on a timeline of the user in the social networking service, following relationships of the user, and posts of the user in which another user's post is quoted.

4. The generation method according to claim 1, further comprising:
extracting, as the tendency of topics, at least one of a number of users who are followed by the user and who have history of spreading fake information formerly, a degree of sharing an identical topic by a followee who is followed by the user and a follower of the user, a frequency of posts in the group, and a magnitude of influence of the user in the group.

5. The generation method according to claim 1, further comprising:
extracting unreliability that indicates a degree of suspicion about reliability of information submitted by the user; and
generating the information that indicates the probability based on the tendency of topics and the unreliability.

6. The generation method according to claim 1, further comprising:
calculating, based on the information that indicates the probability, a premium in a case where the user is an insured of a cyber insurance.

7. The generation method according to claim 1, further comprising:
displaying, based on the information that indicates the probability, an alert related to spreading of fake information in a post of the user.

8. A non-transitory computer-readable recording medium storing a program for causing a computer to execute a process, the process comprising:
extracting a tendency of topics shared by a group to which a user of a social networking service belongs; and
generating information that indicates, based on the tendency of topics, a probability of the user spreading posted fake information.

9. The non-transitory computer-readable recording medium according to claim 8, the process further comprising:
extracting, as the tendency of topics, an echo chamber immersion index obtained by quantifying a degree to which the user is immersed in an echo chamber phenomenon.

10. The non-transitory computer-readable recording medium according to claim 9, the process further comprising:
extracting the echo chamber immersion index based on a timeline of the user in the social networking service, following relationships of the user, and posts of the user in which another user's post is quoted.

11. The non-transitory computer-readable recording medium according to claim 8, the process further comprising:
extracting, as the tendency of topics, at least one of a number of users who are followed by the user and who have history of spreading fake information formerly, a degree of sharing an identical topic by a followee who is followed by the user and a follower of the user, a frequency of posts in the group, and a magnitude of influence of the user in the group.

12. The non-transitory computer-readable recording medium according to claim 8, the process further comprising:
extracting unreliability that indicates a degree of suspicion about reliability of information submitted by the user; and
generating the information that indicates the probability based on the tendency of topics and the unreliability.

13. The non-transitory computer-readable recording medium according to claim 8, the process further comprising:
calculating, based on the information that indicates the probability, a premium in a case where the user is an insured of a cyber insurance.

14. The non-transitory computer-readable recording medium according to claim 8, the process further comprising:
displaying, based on the information that indicates the probability, an alert related to spreading of fake information in a post of the user.

15. An information processing apparatus, comprising:
a memory; and
a processor coupled to the memory and the processor configured to:
extract a tendency of topics shared by a group to which a user of a social networking service belongs; and
generate information that indicates, based on the tendency of topics, a probability of the user spreading posted fake information.

16. The information processing apparatus according to claim 15, wherein the processor is further configured to:
extract, as the tendency of topics, an echo chamber immersion index obtained by quantifying a degree to which the user is immersed in an echo chamber phenomenon.

17. The information processing apparatus according to claim 16, wherein the processor is further configured to:
extract the echo chamber immersion index based on a timeline of the user in the social networking service, following relationships of the user, and posts of the user in which another user's post is quoted.

18. The information processing apparatus according to claim 15, wherein the processor is further configured to:
extract, as the tendency of topics, at least one of a number of users who are followed by the user and who have history of spreading fake information formerly, a degree of sharing an identical topic by a followee who is followed by the user and a follower of the user, a frequency of posts in the group, and a magnitude of influence of the user in the group.

19. The information processing apparatus according to claim 15, wherein the processor is further configured to:
extract unreliability that indicates a degree of suspicion about reliability of information submitted by the user; and
generate the information that indicates the probability based on the tendency of topics and the unreliability.

20. The information processing apparatus according to claim 15, wherein the processor is further configured to:
calculate, based on the information that indicates the probability, premium in a case where the user is an insured of a cyber insurance.
